(19) United States
(12) Patent Application Publication
(10) Pub. No.: US 2007/0180398 A1
(43) Pub. Date: Aug. 2, 2007

(54) Window cleanup via desktop icon

(76) Inventor: James M. McArdle, Austin, TX (US)

Correspondence Address: Greg Goshorn, P.C., 9600 Escarpment, Suite 745-9, AUSTIN, TX, 78749, US

(21) Appl. No.: 11/343,191

(22) Filed: Jan. 30, 2006

(51) Int. Cl. G06F 3/00

(52) U.S. Cl. 715/781; 715/810; 715/835; 715/783

(57) ABSTRACT

Provided is a system and method that enables a user to manage a computer desktop by eliminating clutter. An enhanced desktop tool enables the user to select and/or define rules for managing the windows in the user's desktop. In some embodiments, a method of desktop management is based upon the mix of applications present on the desktop or based upon the preferences of the user as learned by the corresponding GUI by means of observing which windows the users tends to minimize. Possible schemes for managing a desktop include, but are not limited to: 1) All widows are minimized (current method); 2) All windows except last accessed window are minimized; 3) Secondary windows of all applications are minimized; 4) All windows except those of primary application are minimized; and 5) Windows are minimized based upon user-defined heuristics.

### TECHNICAL FIELD

The present invention relates generally to computer interfaces and, more specifically, to a method for managing windows on a computer desktop.

### BACKGROUND OF THE INVENTION

When computers were first invented, instructions, or programs, and data were entered manually via a series of switches. Soon, program and data entry was performed either by means of punch cards or keyboards coupled to the computing devices. Certainly, one of the primary advances in the computing arts has been the introduction of the graphical user interface (GUI). A GUI enables a user to enter data and commands and to execute programs by means of a keyboard and a computer mouse. In addition, a GUI enables a user to manage several executing programs at one time.

The Windows operating system (OS), published by the Microsoft Corporation of Redmond, Wash., is one example of a GUI that enables users easy access to multiple running programs. In Windows, a display, or “desktop,” includes icons, or “buttons,” for programs that are either executing or may be executed and graphical displays, or “windows,” for programs that are active.

As computers have increased with respect to both speed and memory, a user is able to efficiently run more and more programs simultaneously. Although this improves user efficiency, one issue that arises is desktop clutter. In other words, as additional programs are executed, more and more windows are added to the desktop. Users must sift through open windows to access any one particular window. One way to address desktop clutter is to minimize unused windows, i.e. graphically request that a particular window be displayed as an icon rather than as a full window. Windows and Windows XP provide a desktop tool to clear the clutter but the tool typically minimizes all current windows. Although this method clears the desktop, the tool does not discriminate between windows that the user is currently using and those that the user would like to minimize.

### SUMMARY OF THE INVENTION

Provided is a system and method that enables a user to manage a computer desktop by eliminating clutter. An enhanced desktop tool enables the user to select and/or define rules for managing the windows in the user's desktop. The rules are selected or defined in one of several manners. For example, a user can choose desktop management options via a desktop properties dialog. In some embodiments, a method of desktop management is based upon the mix of applications present on the desktop or based upon the preferences of the user as learned by the corresponding GUI by means of observing which windows the users tends to minimize.

There are a number of possible schemes for managing a desktop. For example, one or a combination of the following options may be selected:
All widows are minimized (current method);
All windows except last accessed window are minimized;
Secondary windows of all applications are minimized;
All windows except those of primary application are minimized; and
Windows are minimized based upon user-defined heuristics.

Of course, the policies listed above are only examples; the claimed subject matter is flexible enough to include many different techniques. A user is able to define rules, such as, but not limited to, rules based upon different criteria for different types of applications. For example, an application that has been designated as a primary application may be have a minimization strategy based upon one time interval and a non-primary application may be subject to a minimization strategy based upon another time interval.

This summary is not intended as a comprehensive description of the claimed subject matter but, rather, is intended to provide a brief overview of some of the functionality associated therewith. Other systems, methods, functionality, features and advantages of the invention will be or will become apparent to one with skill in the art upon examination of the following figures and detailed description.

### BRIEF DESCRIPTION OF THE FIGURES

A better understanding of the present invention can be obtained when the following detailed description of the disclosed embodiments is considered in conjunction with the following figures.

FIG. 1 is a block diagram of a computing system that employs the claimed subject matter.

FIG. 2 is an illustration of an exemplary desktop in a first configuration as viewed on the monitor and computing system of FIG. 1.

FIG. 3 is an illustration of the desktop of FIGS. 1 and 2 in a second possible configuration generated by the desktop management tool (DMT) of FIG. 1.

FIG. 4 is an illustration of the desktop of FIGS. 1-3 in a third possible configuration generated by the DMT of FIG. 1.

FIG. 5 is an exemplary DMT Configuration memory object employed in one implementation of the claimed subject matter.

FIG. 6 is a flowchart of an exemplary Setup DMT process that configures and sometimes instantiates the DMT of FIG. 1.

FIG. 7 is a flowchart of an exemplary desktop management process implemented by the DMT of FIG. 1.

FIG. 8 is a flowchart of an exemplary window management process executed by the DMT of FIG. 1.

### DETAILED DESCRIPTION OF THE FIGURES

Although described with particular reference to the Windows operating system and desktop management system, the claimed subject matter can be implemented in any desktop management system in which window optimization and management is desirable. Those with skill in the computing arts will recognize that the disclosed embodiments have relevance to a wide variety of computing environments in addition to those described below. In addition, the methods of the disclosed invention can be implemented in software, hardware, or a combination of software and hardware. The hardware portion can be implemented using specialized logic; the software portion can be stored in a memory and executed by a suitable instruction execution system such as a microprocessor, personal computer (PC) or mainframe.

In the context of this document, a “memory” or “recording medium” can be any means that contains, stores, communicates, propagates, or transports the program and/or data for use by or in conjunction with an instruction execution system, apparatus or device. Memory and recording medium can be, but are not limited to, an electronic, magnetic, optical, electromagnetic, infrared or semiconductor system, apparatus or device. Memory an recording medium also includes, but is not limited to, for example the following: a portable computer diskette, a random access memory (RAM), a read-only memory (ROM), an erasable programmable read-only memory (EPROM or flash memory), and a portable compact disk read-only memory or another suitable medium upon which a program and/or data may be stored.

One embodiment, in accordance with the claimed subject, is directed to a programmed method for managing the appearance of a computer display. The term “programmed method”, as used herein, is defined to mean one or more process steps that are presently performed; or, alternatively, one or more process steps that are enabled to be performed at a future point in time. The term programmed method anticipates three alternative forms. First, a programmed method comprises presently performed process steps. Second, a programmed method comprises a computer-readable medium embodying computer instructions, which when executed by a computer performs one or more process steps. Finally, a programmed method comprises a computer system that has been programmed by software, hardware, firmware, or any combination thereof, to perform one or more process steps. It is to be understood that the term “programmed method” is not to be construed as simultaneously having more than one alternative form, but rather is to be construed in the truest sense of an alternative form wherein, at any given point in time, only one of the plurality of alternative forms is present.

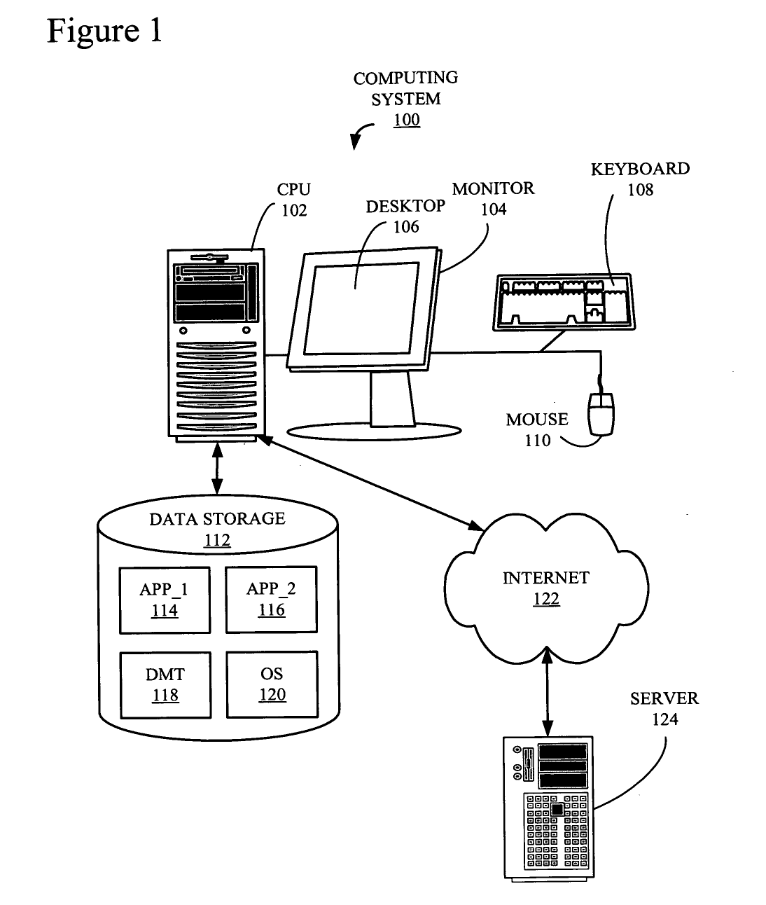

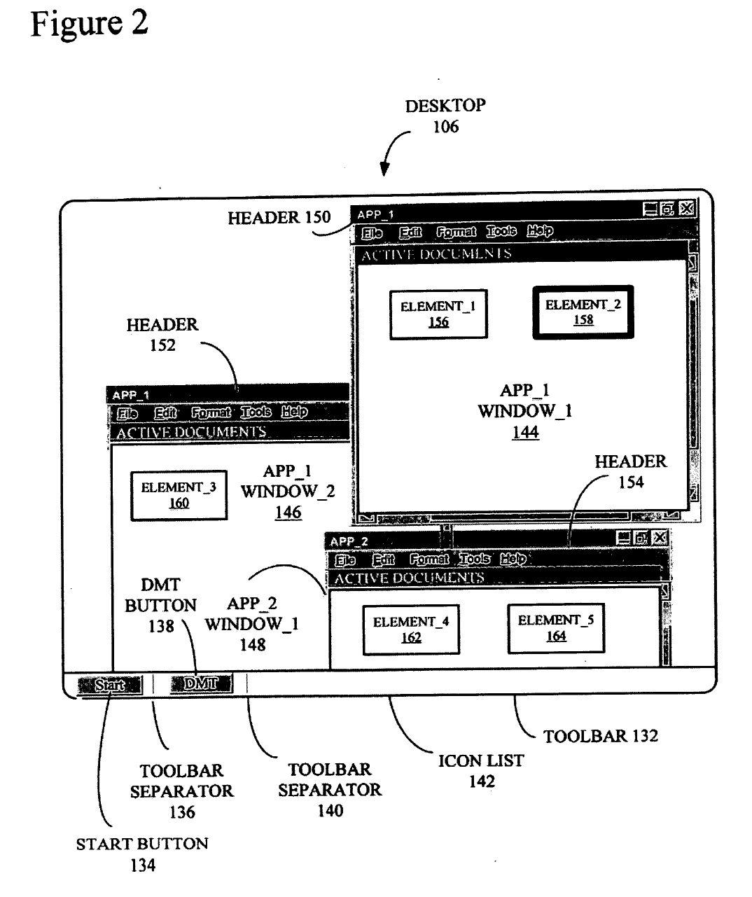

Turning now to the figures, FIG. 1 is a block diagram of an exemplary computing system architecture 100 that incorporates the claimed subject matter. A central processing unit (CPU) 102 is coupled to a monitor 104, a keyboard 108 and a mouse 110, which together facilitate human interaction with CPU 102 and computing system 100. Monitor, or display, 104 presents a desktop 106 to a user. Desktop 106 is shown in more detail below in conjunction with FIGS. 2-4.

Attached to CPU 102 is a data storage component 112, which may either be incorporated into CPU 102 i.e. an internal device, or attached externally to CPU 102 by means of various, commonly available connection devices such as but not limited to, a universal serial bus (USB) port (not shown). Data storage 112 is illustrated storing several exemplary applications, including a first application, or “App_{—1,” 114 and a second application, or “App}_{—2,” 116. Both App}_1 114 and App_2 116 are used for the purpose of illustration only. It should be noted that a typical computing system may include many applications, but for the sake of simplicity only two are shown.

Also stored on data storage 112 is an operating system (OS) 120 and a Desktop Management Tool (DMT) 118 that implements the claimed subject matter. Although shown as a separate module, in an alternative embodiment, DMT 118 may be incorporated into OS 120. DMT 118 is initiated either by a user of computing system 100 or computing system 100 is configured to execute DMT 118 automatically. In this example, DMT 118 executes on CPU 102.

CPU 102 is controlled by operating system (OS) 120, which in this example includes a graphical user interface (GUI), illustrated below in conjunction with FIGS. 2-4. CPU 102 is connected to the Internet 122, which is also connected to a server computer 124. Although in this example, CPU 102 and server 124 are communicatively coupled via the Internet, they could also be coupled through any number of communication mediums such as, but not limited to, a local area network (LAN) (not shown). It should be understood that files such as App_1 114, App_2 116 and DMT 118, as well as many other files accessed by CPU 102 may be stored on memory (not shown) coupled to server 124 and delivered over a LAN or the Internet 122 to CPU 102 and/or data storage 112.

FIG. 2 is an illustration of desktop 106 of FIG. 1 as viewed on monitor 104 (FIG. 1) of computing system 100 (FIG. 1). Various configurations of desktop 106 are employed throughout the remainder of this Description as an example of a display managed by DMT 118 (FIG. 1). In this example, desktop 106 is part of a GUI displayed in conjunction with OS 120 (FIG. 1).

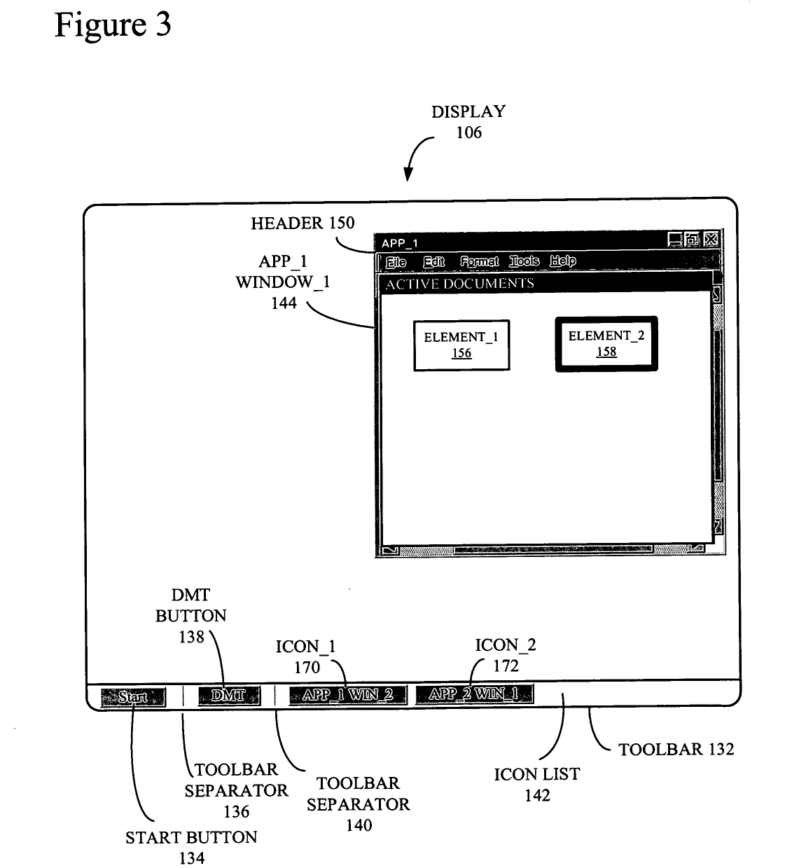

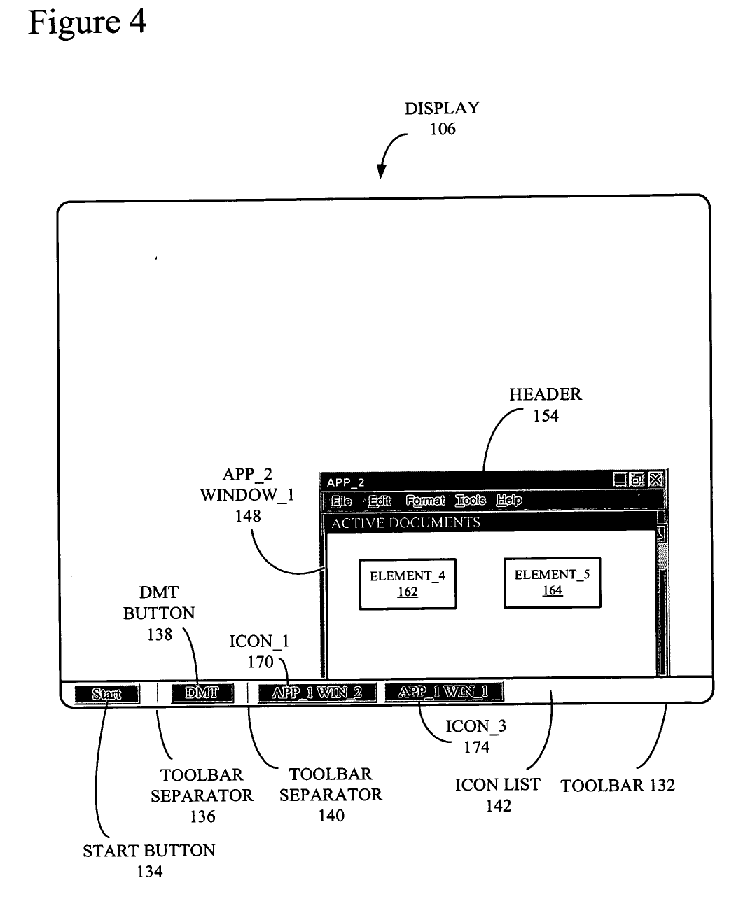

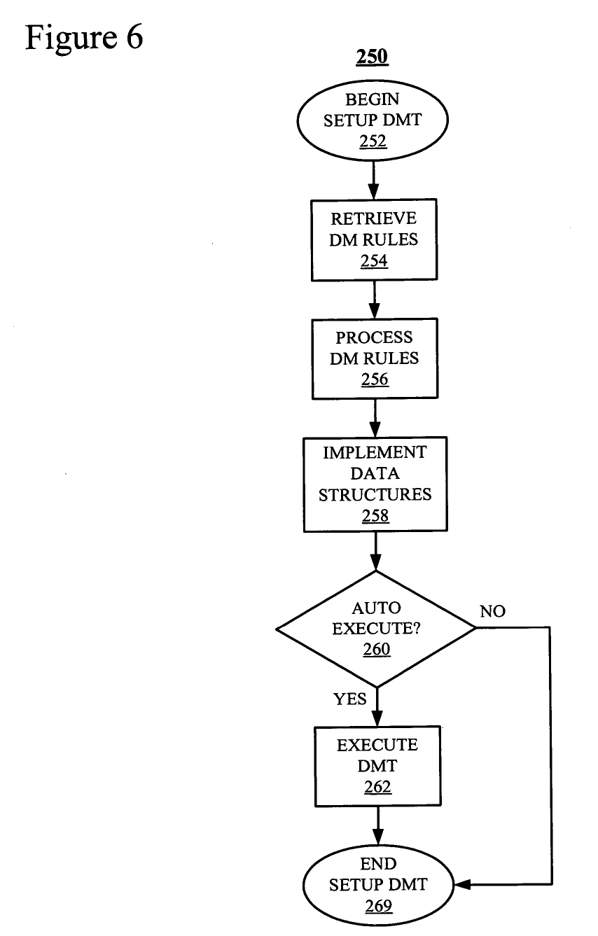

A toolbar 132 extends along the bottom of desktop 106 from the left edge to the right edge of the screen associated with display 104. Within toolbar 132 are a “Start” button 134 and two toolbar separators 136 and 140. In between toolbar separators 136 and 140 is an area that will be referred to a “Quick Launch” area. Quick Launch area displays icons that initiate corresponding applications or utilities when the user positions a cursor (not shown) over a particular icon and presses, or “clicks,” a button (not shown) on mouse 110 (FIG. 1). A DMT button 138, shown within the Quick Launch area of toolbar 132, initiates an executable program associated with DMT 118. Processing associated with DMT 118 is described in more detail below in conjunction with FIGS. 6-8. To the right of toolbar separator 140 in toolbar 132 is an Icon List area 142. Icon list 142 is described in more detail below in conjunction with FIGS. 3 and 4. Those with skill in the computing arts should be familiar with toolbars, quick launch and icon areas as well as the use of a mouse and cursor to initiate actions on computing system 100. Further, it should be understood that icons are sometimes referred to as “buttons” in that actions occur when icons are clicked in much the same way that actions occur when physical buttons, such as those on mouse 110, are pressed.

In FIG. 2, desktop 106 is displaying three windows, two of which are associated with app_1 114 (FIG. 1), i.e. an app_1 window_1 144 and an app_1 window_2 146. A third window in desktop 106 is associated with app_2 116 (FIG. 1), i.e. an app_2 window_1 148. In this example, app_1 window_1 144 is the active window in desktop 106, as evidenced by the fact that a header 150 is darker than a header 152 and a header 154 associated with app_1 window_2 146 and app_2 window_1 148, respectively. It should be noted, that windows 144, 146 and 148 are used only as examples to describe the functionality of the claimed subject matter.

App_1 window_1 144 includes two elements, an element_1 156 and an element_2 158. Element_2 158 is the active element in app_1 window_1 144, or, in other words, has “focus,” as evidenced by the fact that the border of element_2 158 is bolder than the border of element_1 156. The significance with respect to the claimed subject matter of which of the windows and elements are active is described in more detail in conjunction with examples below. Finally, app_1 window_2 146 includes an element_3 160 and app_2 window_1 148 includes an elment_4 162 and an element_5 164.

FIG. 3 is an illustration of desktop 106 of FIGS. 1 and 2 in a configuration generated by desktop management tool (DMT) 118 of FIG. 1 based upon an exemplary configuration in which only the most recently activated window is displayed. Toolbar 132, start button 134, toolbar separators 136 and 140, DMT button 138, app_1 window_1 144, header 150, element_1 156 and element_2 158 are the same as illustrated above in conjunction with FIG. 2. Icon list 142 (FIG. 2) includes an icon_1 170 and an icon_2 172, which are explained below.

In this example, the user has initiated DMT 118 by positioning a cursor over DMT button 138 and clicking on mouse 110 (FIG. 1), thus executing a Manage Desktop process 300 (see FIGS. 6-8). In the following example, DMT 118 is configured to execute in the background on CPU 102 (FIG. 1) once DMT button 138 has been clicked. In an alternative embodiment, DMT 118 executes only once when DMT button 138 is clicked and must be explicitly clicked each time the user desires to manage the windows of desktop 106. In another embodiment, DMT 118 is initiated by a startup script when a user first logs into computing system 100 (FIG. 1) and executes automatically as long as CPU 102 is operating.

In FIG. 3, app_1 window_2 146 (FIG. 2) has been minimized, or “iconified,” and is represented by icon_1 170 in icon list 142 (FIG. 1) of toolbar 132. In a similar fashion, app_2 window_1 148 (FIG. 2) has been minimized and is represented as an icon_2 172 in icon list 142 section of toolbar 132.

The specific windows that are iconified depend upon prior user input and rules defined by a user for DMT 118. FIGS. 3 and 4 represent a scenario based upon a rule in which only the most currently accessed window remains fully displayed, or “open,” and all remaining windows are iconified. Specifically, with respect to FIG. 3, app_1 window_1 144 is the window most recently accessed by the user and therefore remains open and app_l window_2 146 and app_2 window_1 148 have been iconified into icon_1 170 and icon_2 173, respectively. In this manner, DMT 118 is employed to manage desktop 106 by minimizing windows that are not currently of interest to the user. In an alternative embodiment, icon_1 170 and icon_2 172 may be placed somewhere on desktop 106 other than in icon list 142.

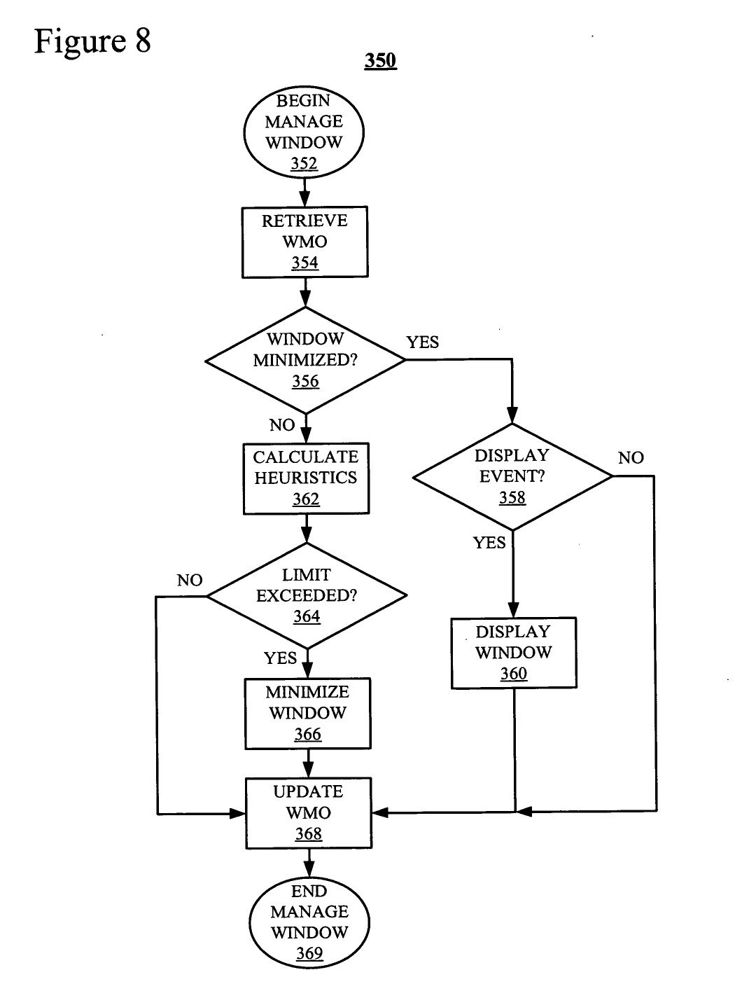

It should be noted that DMT 118 may be configured with many possible rules other than those illustrated in FIGS. 24. For example, DMT 118 may be configured to iconify only windows associated with applications other than the application associated with the most recently accessed window. Under that scenario, app_1 window_1 144 and app_1 window_2 146 would both remain open because of their association with app_1 114 (FIG. 1) and app_2_window_1 148 would be iconified because of its association with app_1 116. Other rules may be based upon a time-based heuristic policy. For example, the following set of rules, which are shown implemented below in conjunction with FIG. 8, may be employed.
Keep all windows of primary (most recently accessed) application open;
Keep primary window of secondary application open if accessed with a set period of time, e.g. N minutes;
Iconify all secondary windows of secondary applications;
Iconify all windows outside of a second period of time, e.g. X minutes;
Iconify all windows outside of a third period of time, e.g. N+X minutes.
   Those with skill in the computing arts should appreciate that there are many possible configurations and sets of rules for DMT 118 that can be applied by employing the techniques of the claimed subject matter. For the sake of simplicity, the following description is limited to two such examples, i.e. rules associated with FIGS. 2-4 and time-based heuristic rules associated with FIG. 8 and explained above.

FIG. 4 is an illustration of desktop 106 of FIGS. 1-3 in a third possible configuration based upon the set of rules first introduced in conjunction with FIGS. 2 and 3. Toolbar 132, start button 134, toolbar separators 136 and 140, DMT button 138 are the same as illustrated above in conjunction with FIGS. 2 and 3. App_2 window_1 148, header 154, element_4 162 and element_5 164 are the same as illustrated above in conjunction with FIG. 2. Icon list 142 (FIGS. 2 and 3) includes icon_1 170 (FIG. 3) and an icon_3 174, which are explained below.

The configuration of FIG. 4 is generated by DMT 118 if the user clicks on icon_2 172 (FIG. 3), thereby activating app_2 116 (FIG. 1). Windows associated with app_1 114 (FIG. 1) are iconified, or “minimized,” i.e. app_1 window_2 146 (FIG. 2) is represented by icon_1 170 and app_1 window_1 144 (FIGS. 2 and 3) is represented by icon_3 174. Icon_2 172 (FIG. 3) is no longer displayed in icon list 142 because corresponding app_2 window 1 148 is open in desktop 106.

As mentioned above, in this example DMT 118 is executing in the background of CPU 102 (FIG. 1) and therefore the actions described above are executed as soon as the user clicks on icon_2 172. In an alternative embodiment, the actions described above do not take place unless DMT button 138 is clicked by the user.

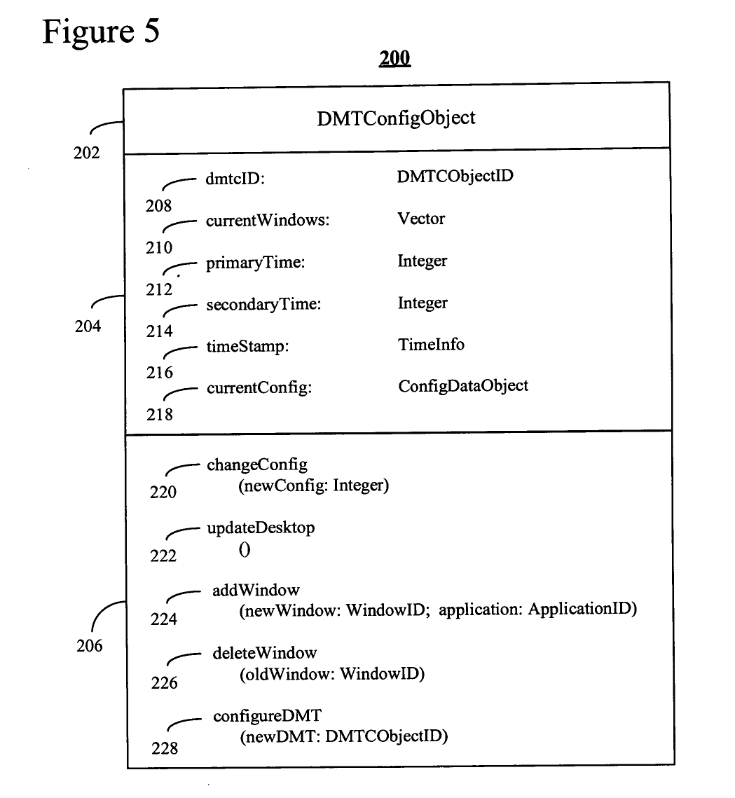

FIG. 5 is an exemplary desktop management tool configuration (DMTC) memory object 200 employed by DMT 118 of FIG. 1 to implement the window management rules of the claimed subject matter. DMTC memory object 200 includes a title section 202, which merely states the name of object 200, i.e. “DMTConfigObject,” an attribute section 204, which contains memory elements, or attributes, associated with DMTC memory object 200, and a method section 206, which includes functions, or methods, that may be executed in conjunction with DMTC memory object 200. It should be noted that the attributes and methods described are used for the purpose of illustration only. Additional and/or different attributes and methods may be employed to implement the claimed subject matter.

Attribute section 202 includes a dmtID attribute 208, a currentWindows attribute 210, a primaryTime attribute 212, a secondaryTime attribute 214, a timeStamp attribute 216 and a currentConfig attribute 218. DmtID attribute 208 is a variable of type DMTCObjectID that contains a reference to the particular instance of object 200. Each instance of object 200 has a unique value for attribute 208 that allows each instance to be uniquely identified. It should be noted that the following description of memory object 200 employs examples from a time-based heuristic configuration of DMT 118 (FIG. 1) such as one implemented by a Manage Window process 350 described below in conjunction with FIG. 8. Those with skill in the computing arts should recognize that there are many other possible configurations of DMT 118 and that each of other possible configurations would likely necessitate additional attributes and methods for implementation.

CurrentWindows attribute 210 is a variable of type Vector that stores a list of windowManagmentObjects (WMOs) (not shown), each of which stores information relating to windows either displayed or minimized on a corresponding desktop. Types of information stored in a WMO includes, but is not limited to, an ID to uniquely identify the corresponding window, an application associated with the window, time information specifying the amount of elapsed time since the window and the window's corresponding application were last accessed, and configuration information including whether or not the window is exempt from the window management policies of DMT 118. In this example, currentWindows 210 would include variables that store identifying and configuration information on the windows of desktop 106 (FIGS. 1-4), i.e. app_1 window_1 144 (FIGS. 2 and 3), app_1 window_2 146 (FIG. 2) and app_2 window_1 148 (FIGS. 2 and 4).

PrimaryTime attribute 212 is a variable of type Integer that stores the number of seconds that DMT 118 allows to elapse before minimizing windows that are associated with the most recently accessed application. For example, if app_1 114 (FIG. 1) is the most recently accessed application and the value of ‘1200’ is stored in attribute 212, then DMT 118 would minimize windows 144 and 146 after 1200 seconds, or twenty minutes, of inactivity. SecondaryTime attribute 214 is a variable of type Integer that stores the number of seconds that DMT 118 allows to elapse before minimizing windows that are not associated with the most recently accessed application. For example, if app_2 116 (FIG. 1) is the most recently accessed application and the value of ‘300’ is stored in attribute 212, then DMT 118 would minimize windows 144 and 146 after 300 seconds, or five minutes, of inactivity. The use of attributes 212 and 214 are explained in more detail below in conjunction with FIGS. 6-8.

Timestamp attribute 216 is a variable of type TimeInfo that stores information corresponding to the times that DMT 118 was executed, instantiated, how often DMT 118 should execute and so on. CurrentConfig attribute 118 is a variable of type ConfigDataObject that stores information concerning the particular window management method currently in use, which as explained above, is a time-based heuristic method in this example.

Method section 204 includes a changeConfig method 220, an updateDesktop method 222, an addWindow method 224, a deleteWindow method 226 and a configureDMT method 228. ChangeConfig method 220 is called when a user desires to change the particular management protocol implemented by DMT 118. As explained above, there are many possible protocols that DMT 118 may implement. In this example, method 220 is called with one parameter, “newConfig,” a variable of type Integer that corresponds to a particular protocol.

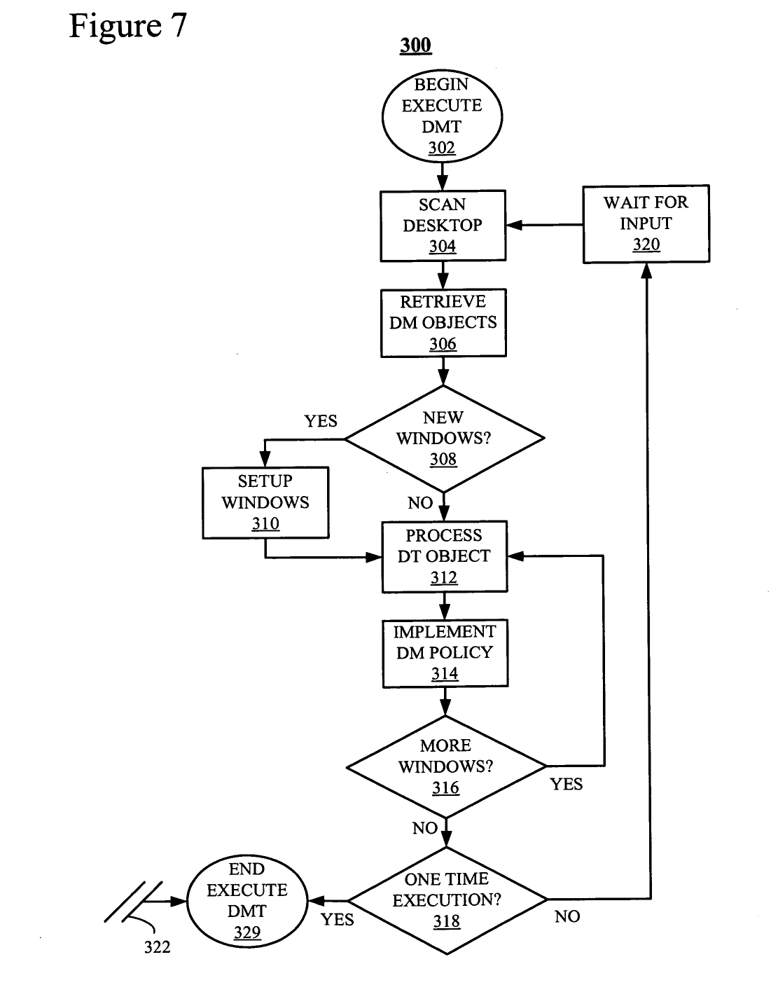

UpdateDesktop method 222 is called to execute the window management processes (see FIGS. 7 and 8) of DMT 118. Method 222 is called when DMT button 138 (FIGS. 2-4) is clicked or periodically if DMT 118 is configured to execute automatically. Method 222 is not called with any parameters. AddWindow method 224 is called when a new window is instantiated. Depending upon the particular implementation of DMT 118 that may be when a new window is detected during a “New Windows?” block 308 (see FIG. 7) or as part of an OS 120 (FIG. 1) interrupt called to instantiate a new window. Method 224 is called with two (2) parameters: a “newWindow” parameter of type WindowID that uniquely identifies the window being added and an “application” parameter of type ApplicationID that identifies a particular application that the subject window is associated. Among other actions, method 224 adds a reference to the subject window into currentWindows attribute 210.

DeleteWindow method 226 is called to remove a window from currentWindows attribute 210 when the corresponding window has been terminated. Among other actions, method 226 removes a reference to the subject window from currentWindows attribute 210. Method 226 is called with one parameter, an “oldWindow” parameter of type WindowID that uniquely identifies the window being deleted. Finally, configureDMT method is called to setup currentConfig attribute 218 so that DMT 118 has ready access to information related to a selected window management scheme. Attribute 228 is called with one parameter, a “newDMT” parameter of type DMTCObject that uniquely identifies the DMT being configured.

FIG. 6 is a flowchart of an exemplary Setup DMT process 250 that configures and sometimes instantiates DMT 118 of FIG. 1. Process 250 starts in a “Begin Setup DMT” block 252 and proceeds immediately to a “Retrieve Desktop Management (DM) Rules” block 254. During block 254, process 250 retrieves a configuration file (not shown) stored on data storage 112 (FIG. 1) in conjunction with DMT 118. The configuration file includes information concerning the desired configuration of DMT 118, including but not limited to, the particular management scheme that is desired to be implemented.

During a “Process Desktop Management (DM) Rules” block 256, process 250 calls configureDMT method 228 to set up the instantiation of DMT 118 according to the parameters stored in the configuration file retrieved during block 254. Among the actions taken during block 256 is the inclusion of DMT button 132 (FIGS. 2-4) on desktop 106 (FIGS. 1-4) so that a user can execute DMT 118 on demand. Another action taken during block 256 is population of currentconfig attribute 218 (FIG. 5) of DMT 118. During an “Implement Data Structures” block 258, process 250 surveys desktop 106 and populates window management objects (WMOs) for any windows either displayed or iconified on desktop 106. As explained above, the WMOs are stored in currentWindows attribute 210 (FIG. 5).

During an “Auto Execute?” block 260, process 250 determines whether or not DMT 118 is configured to execute automatically or only when DMT button 132 is clicked. If DMT 118 is configured to execute automatically, then process 250 proceeds to an “Execute DMT” block 262 during which an Execute DMT process 300 (see FIG. 7) is initiated. Process 250 proceeds from block 262 to an “End Setup DMT” block 269 in which process 250 is complete. If during block 260, process 250 determines that DMT 118 is not configured to execute automatically, then control proceeds to End Setup DMT block 269.

FIG. 7 is a flowchart of an exemplary desktop management process 300 implemented by DMT 118 of FIG. 1. As explained above process 300 is either executed automatically or initiated by user who clicks on DMT button 132 (FIGS. 14) of desktop 106 (FIGS. 1-4). Process 300 starts in a “Begin Execute DMT” block 302 and proceeds immediately to a “Scan Desktop” block 304. During block 304, process 300 determines what windows are represented on desktop 106, both windows actually displayed and those that are minimized and represented by icons.

During a “Retrieve Desktop Management (DM) Objects” block 306, process 300 retrieves the information stored in DMTConfig object 200, for example currentWindows attribute 210 (FIG. 5) and currentConfig attribute 218 (FIG. 5). During a “New Windows?” block 308, process 300 compares the windows determined to be represented on desktop 106 during block 304 with the windows represented by information stored in currentWindows attribute 210. Process 300 then determines whether or not desktop 106 includes windows that are not represented in currentWindows attribute 210. If new windows are detected, process 300 proceeds to a “Setup Windows” block 310 during which a WMO for any new windows is established and currentWindows attribute 210 is updated via a call to addWindow method 224 (FIG. 5). Process 300 then proceeds to a “Process Desktop (DT) object” block 312, explained below.

If process 300 determines during block 308 that all windows on desktop 106 are represented, process 300 proceeds to DT object block 312 and retrieves information about a window represented in currentWindows attribute 210. With respect to the window information retrieved during block 312, during a “Implement DM Policy” block 314, process 300 applies the current window management policy pointed to by the information stored in currentConfig attribute 218, which was retrieved during block 306. The processing of an exemplary time-based heuristic policy is described in detail below in conjunction with FIG. 8.

During a “More Windows?” block 316, process 300 determines whether or not there are any windows represented in currentWindows attribute 210 that have not be processed during this iteration of process 300. If more windows remain to be processed, process 300 returns to block 312, retrieves information about the next unprocessed window and processing continues as described above. If during block 316 process 300 determines that all windows on desktop 106 have been processed, then control proceeds to an “One Time Execution?” block 318 during which process 300 determines whether or not DMT 118 is configures to execute automatically or only when a user or program initiates DMT 118, for example by clicking on DMT button 132 (FIGS. 2-4).

If during block 318 process 300 determines that DMT 118 is configured to execute continuously rather than on a one-time basis, control proceeds to a “Wait For Input” block 320 during which process 300 waits for the next window event. Then, process 300 returns to Scan Desktop block 304 and processing continues as described above. If during block 318 process 300 determines that DMT 118 is configured as a one-time event, control proceeds to an “End Execute DMT” block 329 in which process 300 is complete. Finally, an asynchronous OS Interrupt 322 may also cause process 300 to terminate in block 329. Although, interrupt 322 is typically employed to terminate execution of DMT 118 when DMT 118 is configured to operate continuously, interrupt may also be employed any time during execution of process 300 in response to a CPU 102 (FIG. 1) shutdown or other event that makes the termination of process 300 desirable.

FIG. 8 is a flowchart of exemplary Window Management process 350 executed by DMT 118 of FIG. 1. Process 350, which was first introduced above in conjunction with FIG. 7, is called by desktop management process 300 (FIG. 7) during Implement DM Policy block 314 (FIG. 7). In the following description of process 350, app_1 window_1 144 (FIGS. 2 and 3) is used as an example of the window that is managed.

Process 350 starts in a “Begin Manage Window” block 352 and control proceeds immediately to a “Retrieve WMO” block 354. During block 354, process 350 retrieves a WMO corresponding to the subject window or, in this example, window 144. In an alternative embodiment, information about the subject window may be stored in a database accessible by DMT 118. Those with skill in the computing arts should appreciate that are numerous methods of storing and retrieving information about computing components such as windows and the configuration of DMT 118.

During a “Window Minimized?” block 356, process 350 determines whether or not app_1 window_1 144 is minimized, i.e. iconified, or on display in desktop 106 (FIG. 14). If app_1 window_1 144 is minimized, process 350 proceeds to a “Display Event?” block 358 during which process 350 determines whether or not the event that initiated the call to process 350 represents, with respect to app_1 window_1 144, a window event that would under the current configuration and rules of DMT 118 cause a minimized window to be displayed on desktop 106. For example, under some scenarios of possible rules relating to the display of different windows corresponding to a particular application, window 144 is displayed when either icon_3 174 (FIG. 4) is clicked or app_1 window_2 146 receives focus, either because icon_1 170 (FIGS. 3 and 4) is clicked or input is received within app_1 window_2 146. If process 350 determines that the process 350 initiating event is a maximization event with respect to app_1 window₋1 144, process displays app_1 window_1 144 on desktop 106 during a “Maximize Window” block 360.

If, during block 356, process 350 determines that app_1 window_1 144 is already displayed on desktop 106, control proceeds to a “Calculate Heuristics” block 362. During block 362, process 350 calculates, in the time-based heuristic example employed here, statistics relevant to the current configuration and governing rules of DMT 118 as defined by currentConfig attribute 218 (FIG. 5). Examples of relevant information include, but are not limited to, the current time, the time window 144 was last accessed, the last time a window corresponding to the same application was accessed and the parameters such as primaryTime attribute 212 (FIG. 5) and secondaryTime attribute 214 (FIG. 5).

During a “Limit Exceeded?” block 364, process 350 determines whether or not the heuristics calculated during block 362 represent a condition under the current configuration and rules of DMT 118 in which window 144 is to be minimized. If so, process 350 proceeds to a “Minimize Window” block 366 during which the subject window is minimized, i.e. window 144 is replaced on desktop 106 by icon_3 174 in this example. During an “Update WMO” block 368, process 350 updates any data associated with DMT 118 and/or window 144 relevant to the implementation of the claimed subject matter, regardless of where and how such data is stored. Finally, process 350 proceeds to an “End Process Window” block 369 in which process 350 is complete.

While the invention has been shown and described with reference to particular embodiments thereof, it will be understood by those skilled in the art that the foregoing and other changes in form and detail may be made therein without departing from the spirit and scope of the invention, including but not limited to additional, less or modified elements and/or additional, less or modified blocks performed in the same or a different order.

We claim:

1. A method for managing for managing a computer application desktop, comprising:
defining a set of rules for managing a plurality of windows on a desktop;
tracking application window activity corresponding to each individual window of the plurality of windows;
receiving a command to apply the set of rules;
applying the set of rules individually to each window of the plurality of windows; and
managing each individual window based upon an application of the set of rules as the rules apply to each individual window and the tracked application window activity.

2. The method of claim 1, further comprising:
correlating a first subset of the plurality of windows to a first application;
assigning a first time value to the first application; and
managing each individual window of the first subset based upon the first time value.

3. The method of claim 2, further comprising:
detecting activity associated with the first application; and
transmitting the command to apply the set of rules when activity is detected.

4. The method of claim 2, further comprising:
correlating a second subset of the plurality of windows to a second application, wherein the second subset is distinct from the first subset;
assigning a second time value to the second application; and
managing each window of the second subset based upon the second time value.

5. The method of claim 4, wherein the first application is an application that is active on the desktop and the second application is an application that is non-active on the desktop.

6. The method of claim 1, wherein the set of rules are user defined time-based heuristics.

7. The method of claim 1, further comprising:
detecting window activity associated with the plurality of windows; and
transmitting the command to apply the set of rules when window activity is detected.

8. A system for managing for managing a computer application desktop, comprising:
a set of rules for managing a plurality of windows on a desktop;
logic for tracking application window activity corresponding to each individual window of the plurality of windows;
logic for receiving a command to apply the set of rules;
logic for applying the set of rules individually to each window of the plurality of windows; and
logic for managing each individual window based upon an application of the set of rules as the rules apply to each individual window and the tracked application window activity.

9. The system of claim 8, further comprising:
logic for correlating a first subset of the plurality of windows to a first application;
a first time value corresponding to the first application; and
logic for managing each individual window of the first subset based upon the first time value.

10. The system of claim 9, further comprising:
logic for detecting activity associated with the first application; and
logic for transmitting the command to apply the set of rules when activity is detected.

11. The system of claim 9, further comprising:
logic for correlating a second subset of the plurality of windows to a second application, wherein the second subset is distinct from the first subset;
a second time value corresponding to the second application; and
logic for managing each window of the second subset based upon the second time value.

12. The system of claim 11, wherein the first application is an application that is active on the desktop and the second application is an application that is non-active on the desktop.

13. The system of claim 8, wherein the set of rules are user defined time-based heuristics.

14. The system of claim 8, further comprising:
logic for detecting window activity associated with the plurality of windows; and
logic for transmitting the command to apply the set of rules when window activity is detected.

15. A computer programming product for managing for managing a computer application desktop, comprising:
a memory,
a set of rules, stored on the memory, for managing a plurality of windows on a desktop;
logic, stored on the memory, for for tracking application window activity corresponding to each individual window of the plurality of windows;
logic, stored on the memory, for receiving a command to apply the set of rules;
logic, stored on the memory, for applying the set of rules individually to each window of the plurality of windows; and
logic, stored on the memory, for managing each individual window based upon an application of the set of rules as the rules apply to each individual window and the tracked application window activity.

16. The computer programming product of claim 15, further comprising:
logic, stored on the memory, for correlating a first subset of the plurality of windows to a first application;
a first time value, stored on the memory, corresponding to the first application; and
logic, stored on the memory, for managing each individual window of the first subset based upon the first time value.

17. The computer programming product of claim 16, further comprising:
logic, stored on the memory, for detecting activity associated with the first application; and
logic, stored on the memory, for transmitting the command to apply the set of rules when activity is detected.

18. The computer programming product of claim 16, further comprising:
logic, stored on the memory, for correlating a second subset of the plurality of windows to a second application, wherein the second subset is distinct from the first subset;
a second time value, stored on the memory, corresponding to the second application; and
logic, stored on the memory, for managing each window of the second subset based upon the second time value.

19. The computer programming product of claim 15, wherein the set of rules are user defined time-based heuristics.

20. The computer programming product of claim 15, further comprising:
logic, stored on the memory, for detecting window activity associated with the plurality of windows; and
logic, stored on the memory, for transmitting the command to apply the set of rules when window activity is detected.
